(19) United States
(12) Patent Application Publication
(10) Pub. No.: US 2007/0059225 A1
(43) Pub. Date: Mar. 15, 2007

(54) Ultraviolet light filtration apparatus

(76) Inventor: Christopher A. Willette, Tequesta, FL (US)

Correspondence Address: BROWN & MICHAELS, PC;400 M & T BANK BUILDING, 118 NORTH TIOGA ST, ITHACA, NY, 14850, US

(21) Appl. No.: 10/557,667

(22) PCT Filed: May 13, 2005
(86) PCT No.: PCT/US05/16975

§ 371 Date: Nov. 22, 2005

Related U.S. Application Data
(60) Provisional application No. 60/571,384, filed on May 14, 2004.

(51) Int. Cl. B01J 19/12

(52) U.S. Cl. 422/186.3

(57) ABSTRACT

In the present invention a germicidal ultraviolet light apparatus is mounted within a specially designed filter element that is designed to fit within the standard filter access ports for re-circulating (HVAC) air systems. The ultraviolet light source is positioned to project ultraviolet light towards surfaces found within the filter area and components found downstream of the filter in the HVAC system for the purpose of sterilization and maintenance of these areas. Preferably, the filter elements contain a special tackified air filtration media designed to increase the reactivity of the UV light within the filter area. In addition, the present invention includes a safety interlock mechanism that cuts power to the UV source when the filter element is removed from the re-circulating air system. Finally, the present invention involves various sources of supplying power to the UV apparatus for installation flexibility.

### REFERENCE TO RELATED APPLICATIONS

This application claims an invention which was disclosed in Provisional Application No. 60/571,384, filed May 14, 2004, entitled “Ultraviolet Light Filtration Apparatus”. The benefit under 35 USC §119(e) of the United States provisional application is hereby claimed, and the aforementioned application is hereby incorporated herein by reference.

### BACKGROUND OF THE INVENTION

1. Field of the Invention

The present invention relates to an ultraviolet light air filter apparatus for application into typical air filtration ports found in heating, ventilating and air conditioning (HVAC) systems. The device is intended for the reduction and control of organic contamination that can occur on the air filtration element and surrounding components within the re-circulating air system.

2. Description of Related Art

Contaminants including particulates and organics contaminants such as algal, fungal, bacterial, and viral agents in re-circulating air system components are a widespread indoor air related problem in homes and buildings with central heating, ventilation, and air-conditioning (HVAC) systems and is a potential source of contamination of the occupied air space. Organic growth has been found growing on air filters, insulation, cooling coils, and drain pans as well as in ducts of re-circulating air systems. This contamination, if unchecked, can contribute to building-related illnesses and diseases, including both infectious diseases and hypersensitivity diseases.

Control of contamination in indoor environments has traditionally focused on source control, ventilation, and air cleaning. Source control emphasizes the reduction or elimination of sources of contamination such as moisture or humidity to limit organic growth. Although this can be effective in many areas, it is not always achievable in HVAC systems during cooling. By design, air-conditioning systems cause moisture to condense from air. This condensation effect often times provides an ideal environment for organic growth and resultant contamination of surfaces and reduced operating efficiency of air system components. As a result, other methods are needed to reduce this contamination.

Ventilation relies on using a percentage of filtered outdoor air. Ventilation is ineffective, however, when unfiltered outdoor air introduces outdoor contamination, when the HVAC system itself is contaminated, or when applying a ventilation method to an existing system is impractical.

Air cleaning has focused mainly on using properly maintained air filters within HVAC systems to remove and trap airborne contaminants from the air stream. This method is ineffective when proper maintenance or replacement of these filters is not followed. Build-up of contaminants on the filter elements can result in a breeding ground for potentially high levels of contaminants. Further, it can lead to filter blockage that can affect air flow rates and system performance. The lack of maintenance of the air filtration elements tends to be the most prominent initial source of contamination within re-circulating air systems.

For many years, air filtration has been an area in re-circulating air systems that has been highly overlooked and neglected. Standard filter access ports, filter housing and filter back grills have been designed to accept standard 1″ thick air filters which are readily available from retail stores, air conditioning contractors and wholesalers. These filter elements are often times insufficient to properly filter the air flowing through the HVAC system and can be the starting point for the collection, growth and spread of organic contamination within the HVAC system. Improvements to these filter elements have been made over the years to enhance filtration efficiency and sterility. (See, e.g., U.S. Pat. Nos. 6,136,058 and 6,764,533). However, these improvements, if left un-checked, can also magnify the problem by blocking the air flow and reducing the air handling system's overall efficiency and performance.

### SUMMARY OF THE INVENTION

This invention intends to improve upon the application of air filtration elements by providing a means to help maintain these elements through the use of germicidal ultraviolet light, which can prevent organic fouling from occurring and spreading. In addition, when the ultraviolet light element is applied to specially formulated air filtration elements designed to enhance the ultraviolet light reactivity, improved organic filtration efficiency can be achieved and improved indoor air quality can result.

By applying the present invention's ultraviolet light apparatus to either a specially designed “U reactive” filter element or standard readily available filter elements, enhancement to the air filtration process can be achieved. The application of the ultraviolet light apparatus to air filtration elements helps to immediately sterilize captured organic contaminants—preventing them from flourishing and spreading.

Thus, the present invention involves an application method of an ultraviolet light apparatus designed to be applied to various configurations and sizes of readily available air filtration elements that are used in air movement apparatus (such as re-circulating heating, ventilation and air conditioning (HVAC) systems) for the purpose of both filter and surrounding surface sterilization and maintenance.

It also involves a germicidal ultraviolet light (UV) apparatus mounted within a specially designed filter element that is designed to fit within the standard filter access ports for re-circulating air systems such as those found in heating ventilating and air conditioning systems (HVAC). The UV apparatus is intended to be mounted within the filter area of these specially designed filter elements such that the ultraviolet light source can be positioned to project the ultraviolet light towards surfaces found within the filter area and the surrounding air stream and components found downstream of the filter in the HVAC system for the purpose of sterilization and maintenance of these areas. In addition, these specially designed filter elements shall contain a special tackified air filtration media such as that offered by Superior Fiber, Inc., designed to increase the reactivity of the UV light within the filter area. (See, also, U.S. Pat. No. 6,136,058). Plus, further enhancement to the filtration media can be achieved by applying an electrical charge to the filter media to increase its ability to attract airborne particulate. (See, e.g., U.S. Pat. No. 6,764,533). These surfaces are often times problematic areas that fester organic growth that can pose potential health problems and reduce the efficiency of operation of the re-circulating air system.

In addition, the present invention involves a safety interlock mechanism in combination with the UV apparatus to prevent accidental exposure to the ultraviolet light source. This safety interlock cuts power to the UV source of the UV apparatus when the filter element is removed from the filter housing of the re-circulating air system.

Further, the present invention involves various sources of supplying power to the UV apparatus for installation flexibility. As the type of re-circulating HVAC systems can vary greatly, so can the installation method of the air filtration elements and the method for supplying power to the UV apparatus.

Finally, the present invention involves a method for the reduction of typical indoor odors through the combination of ultraviolet light spectrums emitted by the UV apparatus. The combination of UV spectrums produces a UV oxidative effect that increases the UV's reactivity with odors and other volatile organic compounds (VOC's).

### BRIEF DESCRIPTION OF THE DRAWINGS

FIGS. 1A and 1B provide schematic views of the UV apparatus of my invention.

FIG. 1A provides a top view of the UV apparatus.

FIG. 1B provides an end view of the UV apparatus.

FIGS. 2A, 2B and 2C provide schematic views of the safety interlock mechanism of my invention.

FIG. 2A provides a top view of the safety interlock mechanism.

FIG. 2B provides a side view of the safety interlock mechanism.

FIG. 2C provides an end view of the safety interlock mechanism.

FIGS. 3A, 3B, and 3C provide schematic views of a specially designed filter element of my invention.

FIG. 3A provides a top view of the specially designed filter element.

FIG. 3B provides a side view of the specially designed filter element.

FIG. 3C provides an end view of the specially designed filter element.

FIGS. 4A, 4B, and 4C schematically illustrate the use of my TV apparatus in conjunction with a standard air filter element.

FIG. 4A provides a top view of my UV apparatus used in conjunction with a standard filter element.

FIG. 4B provides a side view of my UV apparatus used in conjunction with a standard filter element.

FIG. 4C provides an end view of my UV apparatus used in conjunction with a standard filter element.

FIGS. 5A, 5B, and 5C schematically illustrate a series of power supply methods that can be used to power the UV apparatus of my invention.

FIG. 5A illustrates a direct wired power supply designed to be connected directly to the main power feed of an air handling unit (AHIJ).

FIG. 5B illustrates a duct mounted power supply designed for mounting to an air duct system.

FIG. 5C illustrates a power supply option intended for direct connection to a local electrical outlet.

FIGS. 6A, 6B, and 6C schematically illustrate various configurations for applying the UV apparatus and related filtration elements of my invention into different types of air handling system configurations.

FIG. 6A illustrates the UV filter apparatus applied in typical standard filter access points found on typical air conditioning, heating and heat pump air handling units.

FIG. 6B illustrates the TV filter apparatus applied in a standard filter backed return air grill.

FIG. 6C illustrates the UV apparatus applied in typical filter arrays found on commercially sized air handling systems.

FIG. 7 provides a partially exploded perspective view of an embodiment of the instant invention

### DETAILED DESCRIPTION OF THE INVENTION

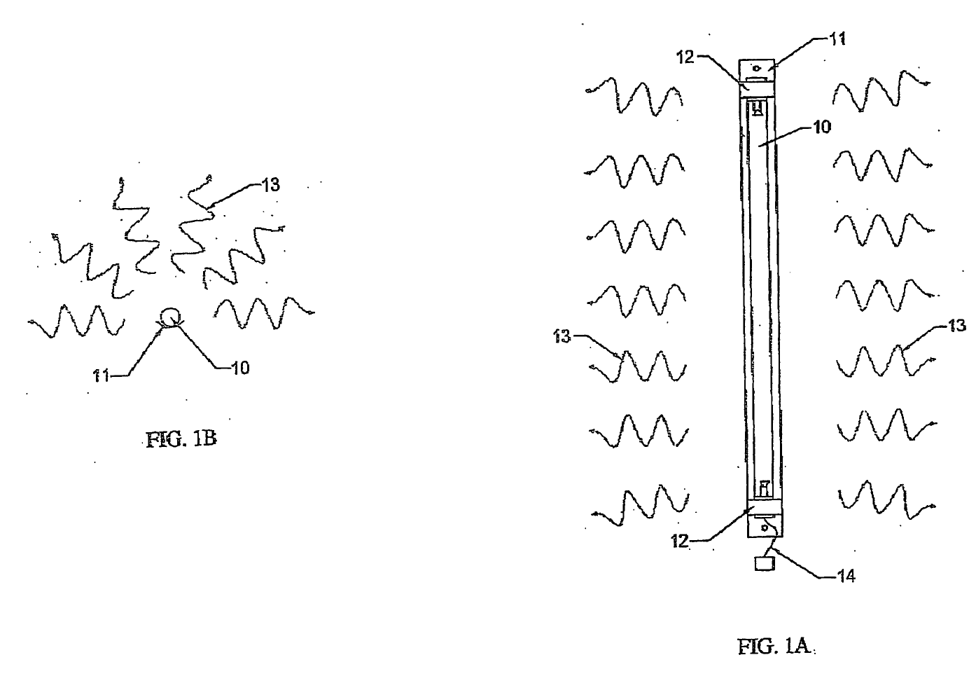

FIGS. 1A and 1B refer to the UV apparatus of my invention. This apparatus includes an ultraviolet light source 10, which is intended to generate germicidal ultraviolet light for the purpose of sterilization of organic contaminants. This UV light source 10 can include either a mercury vapor type of light source or light emitting diodes (LED's) with light energy's ranging in the ultraviolet light ranges of UVA, UVB or UVC with specific concentrations in the UVC germicidal band range. The germicidal band range is approximately 200-300 nm, with a peak germicidal effectiveness at approximately 254 nm. The germicidal process involves absorption of a UV photon in this range by microbial DNA chains. This causes a disruption of the DNA chain, such that when a cell undergoes mitosis (cell division), the replication of DNA is inhibited, and the cell is unable to reproduce (i.e., is sterilized). This process prevents further growth of cell colonies, such as mold, and eventually the colony will die off.

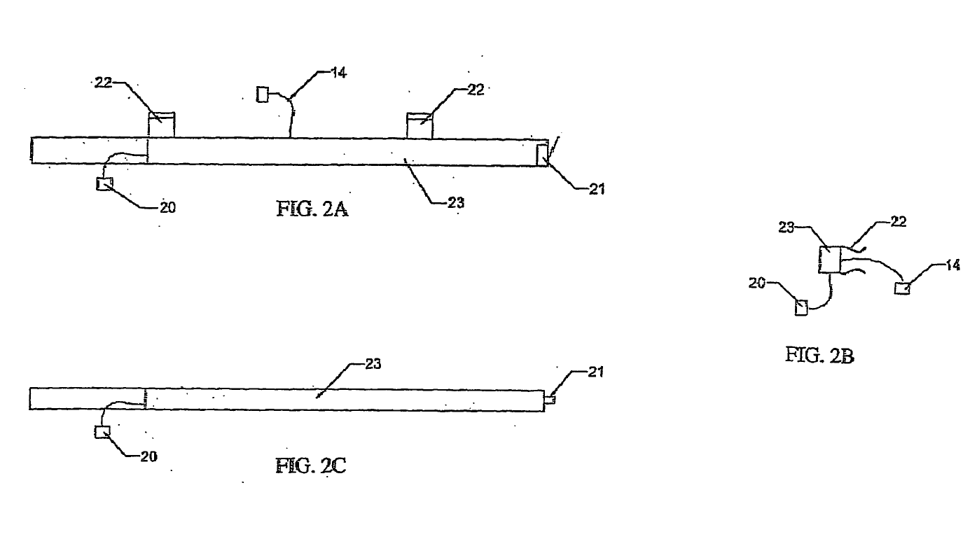

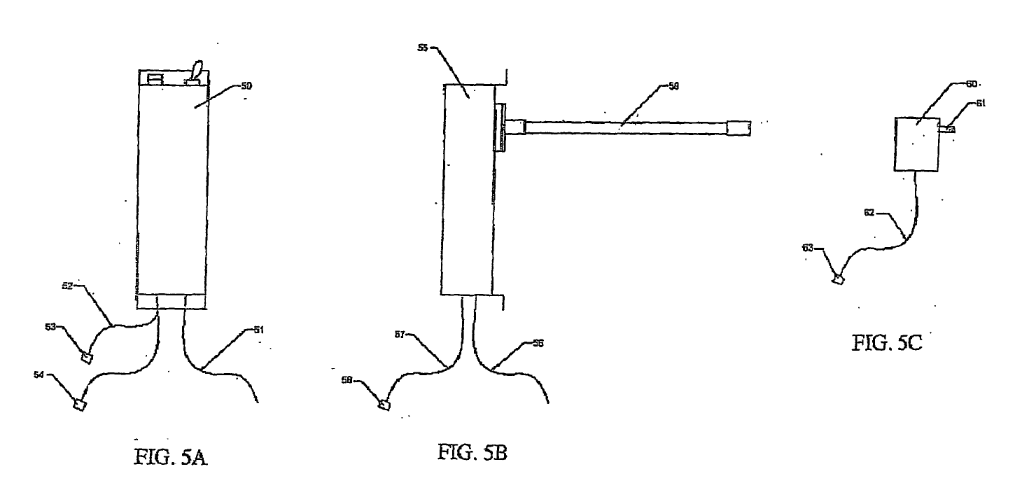

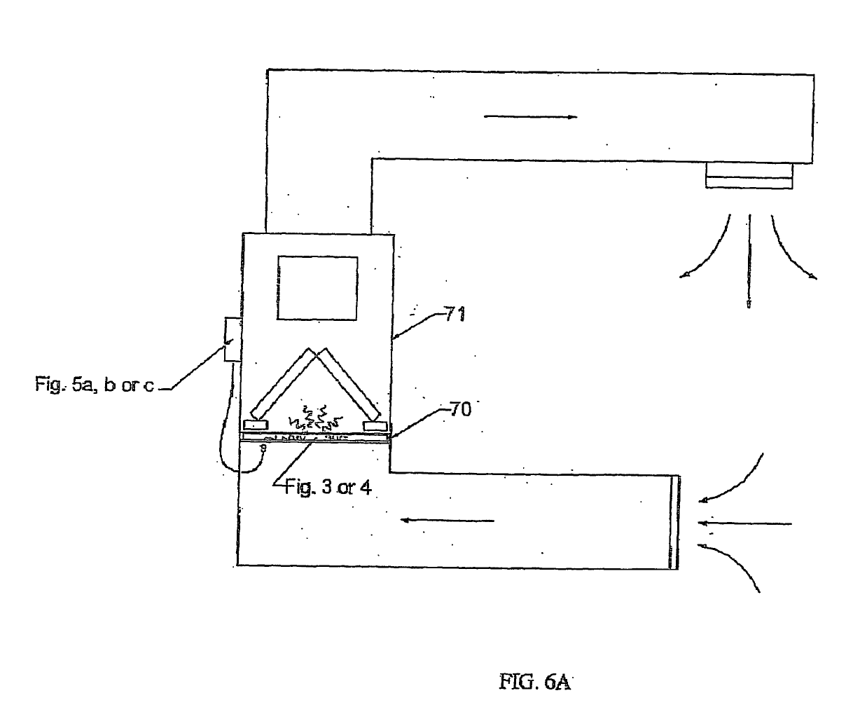

The UV light source 10 is mounted to a UV shield 11. The UV light source 10 is fixed to the UV reflector (shield 11) via specially designed tabs 12 on the UV shield. The UV shield 11 serves as a fixture for the UV light source as well as a means to direct the UV light towards the areas intending to be sterilized 13, The UV light source 10 is wired to a short multi-wire “pigtail” with a lamp connector 14 on the opposite end for the purpose of electrically connecting the UV light source to a safety interlock (FIG. 2) and corresponding power supply (FIG. 5) options.

FIG. 2 refers to a safety interlock mechanism that is comprised of a lamp connector 14, power supply connector 20, safety interlock disconnect consisting of a lever activated switch 21, and housing 23. The safety interlock mechanism serves to function as a power disconnect to the UV lamp in the event the UV apparatus when mounted to a filter is removed from the filter cavity, thus disconnecting power and preventing accidental exposure to the ultraviolet light rays. The lever switch 21 when activated, disconnects power from the UV lamp apparatus (FIGS. 1A-1B) preventing it from operating. The safety Interlock mechanism can be mounted with optional U-shaped brackets 22 for the purpose of attaching it to the edge of standard filter elements.

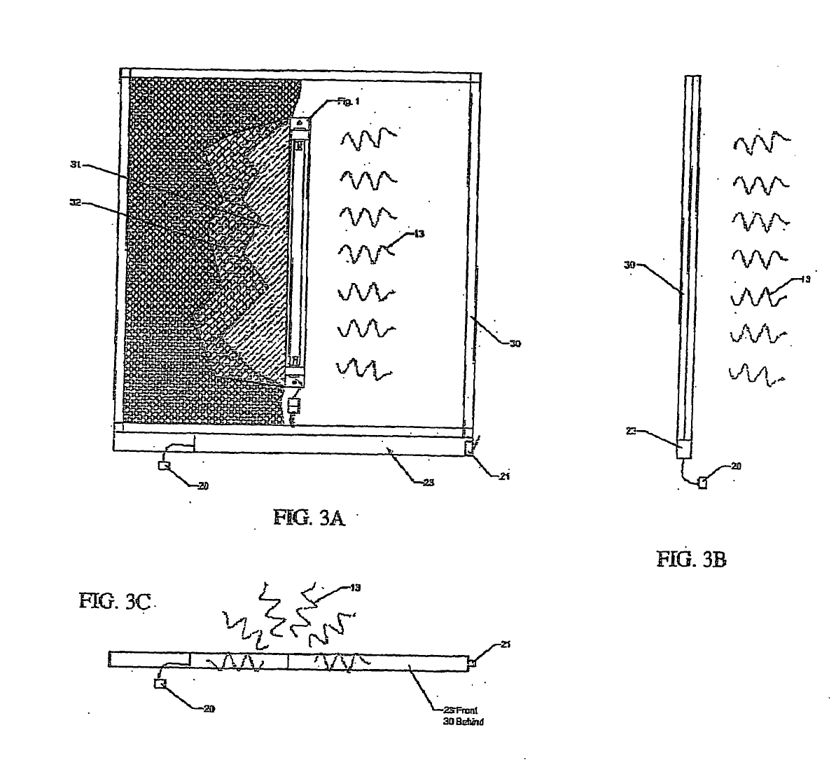

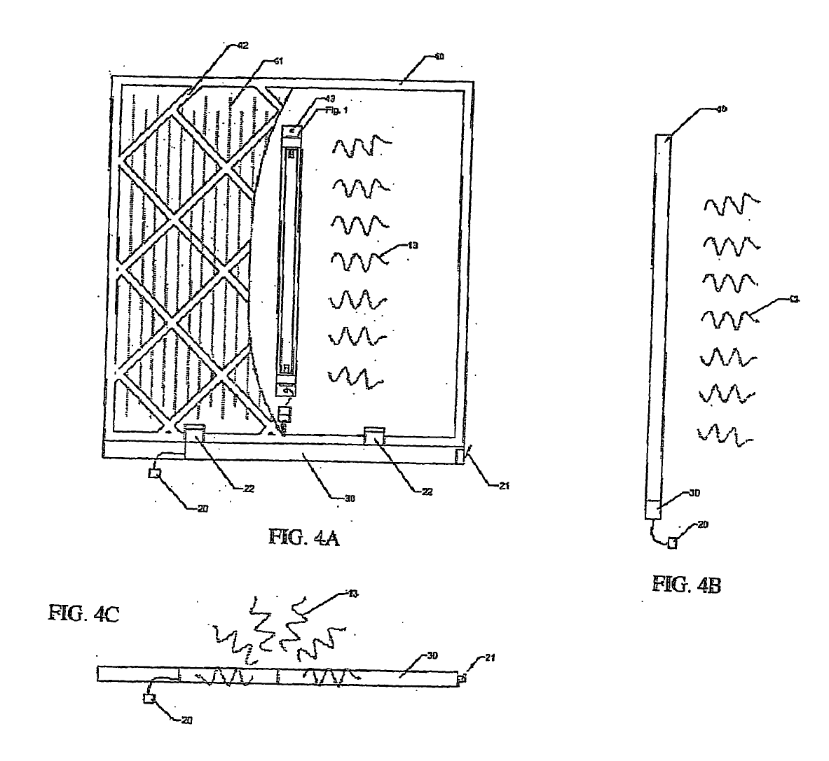

FIG. 3 refers to a specially designed filter element in which the filter elements materials are specifically formulated to enhance the reactivity of the UV apparatus (FIGS. 1A-1B) with the organic contaminants. This specially designed filter housing 30 can be configured to accept multiple layers of filtration media 31, 32 specifically chosen to increase the sterilization efficiency of the UV apparatus (FIG. 1). For example, one or both layers can be of ordinary materials used for this purpose or of enhanced materials. In terms of enhanced materials, I have found it advantageous to form both layers from a material with a tackified surface as previously discussed and as known in the art. The UV apparatus (FIG. 1) is positioned in such a fashion as to project the UV light rays 13 through the filtration media 31, 32 to enhance the reactivity of the UV light rays with locally captured organic contaminants. In addition, the UV light rays 13 are allowed to project downstream of the filter element to treat the airborne and surrounding areas.

The use of UV light in my invention creates synergistic effects that greatly enhance the overall function of the invention. For example, I have found that fiberglass is by and large transparent to UV even when it is opaque to ordinary light. In addition, I have found that, due to their transparency to UV, fiber glass fibers can absorb and channel UV in a fiber optic manner. This means that the light from a single UV source (as shown in my drawings) is not trapped or blocked by fiberglass materials, but actually penetrates and permeates the fiberglass filter. In fact, fiberglass can be thought of as a means of UV light wicking in the manner that ordinary cloth fibers absorb and wick moisture. This greatly assists in the distribution of UV energy throughout the filter to fiber surfaces bearing pathogens to be sterilized. Further, the UV can create ionization on the surface of the fibers, creating a charge and further enhancing tackification in this manner. Finally, it is possible to coat fibers with photocatalytic coatings such as titanium dioxide. Materials of this type have increased oxidation effects when exposed to UV, further enhancing the effectiveness of my invention.

FIG. 4 refers to the application of the UV apparatus (FIGS. 1A-1B) into a standard air filter element 40. Standard pleated filter elements 40 typically consist of a pleated filter element 41 and cardboard outer casing 42 that contains the pleated filter element 41 within the confines of the filters intended design. This outer cardboard casing 42 will typically have a cross pattern designed to hold the pleated filter element 41. The UV apparatus (FIGS. 1A-1B) can be inserted into these typical air filter elements 40 by lifting the cardboard casing 42 and sliding the UV apparatus (FIGS. 1A-1B) down the groove of one of the filters pleats. The cardboard casing 41 and special snap rivets 43 serve as a means to secure the UV apparatus (FIG. 1) within the filters confines for the purpose of sterilizing the filter element and surrounding area. In addition, the UV light rays 13 are allowed to project downstream of the filter element to treat the airborne and surrounding areas.

FIGS. 5A, 5B and 5C refers to a series of power supply methods that can be incorporated to power the UV apparatus (FIGS. 1A-1B).

FIG. 5A refers to a power mediation unit in the form of a direct wired power supply designed to be connected directly to the main power feed of an air handling unit (AHU) and mounted within the interior or surrounding area of the AHU. This power supply is designed to handle the extreme environments found in this application—such as the wet, cold environment found within the interior of the air handler or potential exposure to the outdoor weather elements when the power supply is mounted exterior to the air handler. The power supply consists of a weather resistant power supply housing 50, a wire harness 51 for connecting directly to the main power feed for the air handler, a remote cable 52 and power supply connector 53 for connection to the safety interlock (FIG. 2) and UV apparatus (FIGS. 1A-1B), and an optional 2^{nd} remote cable 54 for connection of a second UV apparatus.

FIG. 5B refers to a duct mounted power supply designed for mounting of the power supply to an air duct system. This power supply is designed to provide a means of mounting the power supply onto a duct systems where power to the UV apparatus can be supplied and a second UV apparatus can be directly applied to the power supply for local area UV treatment. The power supply consists of an air duct mountable power supply housing 55, a wire harness 56 for connecting directly to the main power feed for the air handler or for plugging into a local electrical outlet, a remote cable 57 and power supply connector 58 for connection to the safety interlock (FIG. 2) and UV apparatus (FIGS. 1A-1B), and a second UV apparatus 59 mounted directly to the power supply housing for local area UV treatment.

FIG. 5C refers to a power supply option for direct connection of the power supply to a local electrical outlet. The power supply consists of a small electronic power pack 60 with standard 120 VAC prongs 61 for plugging into standard electrical outlets, and a remote cable 62 and power supply connector 63 for connection to the safety interlock (FIG. 2) and UV apparatus (FIGS. 1A-1B).

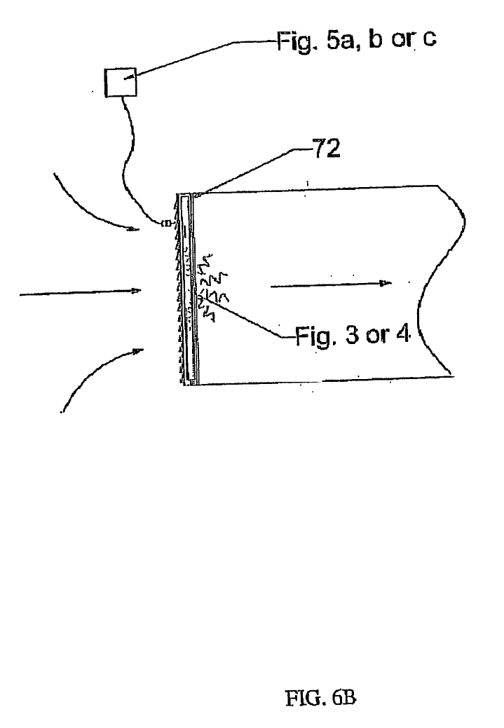

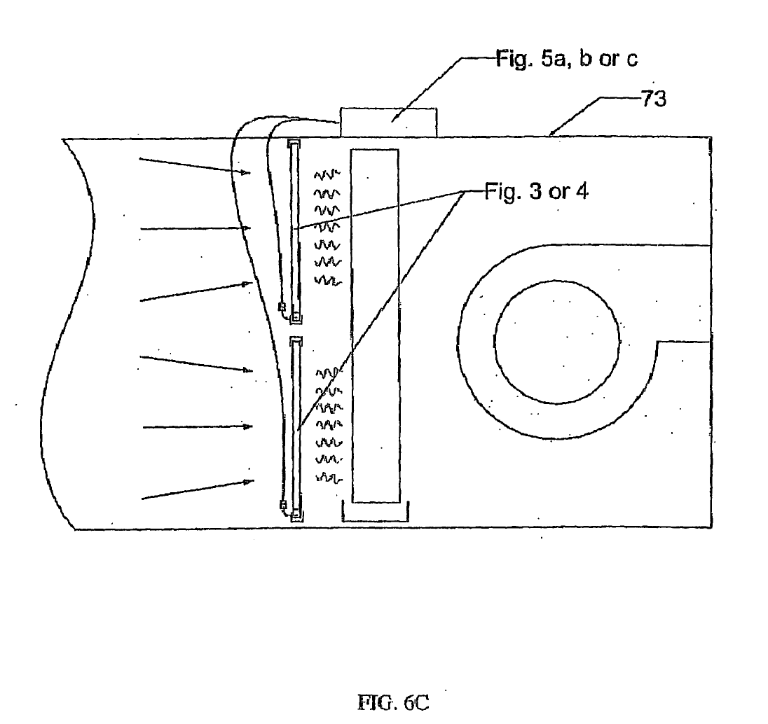

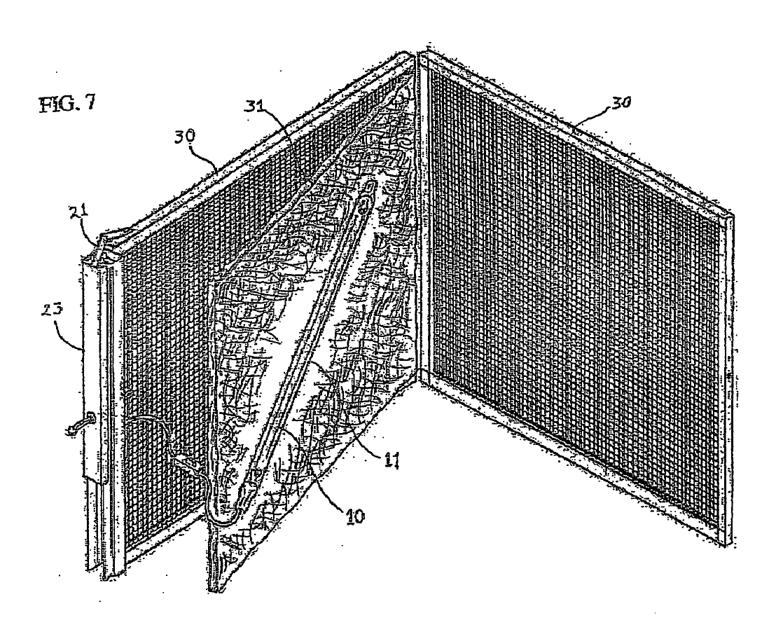

FIGS. 6A, 6B and 6C refer to various configurations of applying the UV apparatus (FIGS. 1 and 2) and related filtration elements (FIGS. 3 and 4) into different types of air handling system configurations. FIG. 6A refers to applying the UV filter apparatus (FIGS. 3 and 4) into typical standard filter access points 70 found on typical air conditioning, heating and heat pump air handling units (AHU) 71. In this application, the UV filtration apparatus (FIG. 3 or 4) is applied to the standard filter access ports 70 found on these styles of air handling units. FIG. 6B refers to the application of the UV filter apparatus (FIG. 3 or 4) into a standard filter backed return air grill 72. FIG. 6C refers to the application of the UV apparatus (FIG. 3 or 4) to typical filter arrays found on commercially sized air handling systems 73.

Notwithstanding the foregoing preferred embodiments, many variations are possible without exceeding the scope of the inventive concepts set forth herein. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. An air filtration apparatus with ultraviolet light, comprising an ultraviolet light source within a filter mount, which filter mount is adapted to fit within a filter access port for a re-circulating air system.

2. An air filtration apparatus as described in claim 1, further including an air filtration medium in said filter mount.

3. An air filtration apparatus as described in claim 2, wherein said ultraviolet light source is positioned so as to irradiate said air filtration medium.

4. An air filtration apparatus as described in claim 2, wherein said ultraviolet light source is positioned at least one of: adjacent said air filtration medium and in said air filtration medium.

5. An air filtration apparatus as described in claim 1, further comprising a reflector to direct ultraviolet light emitted by said ultraviolet light source.

6. An air filtration apparatus as described in claim 5 wherein said recirculating air system creates a directional air flow and said reflector directs a portion of said ultraviolet light in the direction of said air flow.

7. An air filtration apparatus as described in claim 1, further comprising a safety interlock causing said ultraviolet light source to cease emitting ultraviolet light when said filter mount is withdrawn from said filter access port.

8. An air filtration apparatus as described in claim 3, wherein at least one of filtration and sterilization by said air filtration medium is enhanced by factors enabling elements of said air filtration medium to at least one of: better attract contaminants, better retain contaminants, better irradiate contaminants with ultraviolet light, and better oxidize contaminants.

9. An air filtration apparatus as described in claim 8, wherein said factors include at least one of: an electric charge on elements of said air filtration medium enabling said elements to better attract and retain contaminants, tackification of elements of said air filtration medium enabling said elements to better retain contaminants, and ultraviolet light conductivity of elements of said air filtration medium enabling said ultraviolet light to better irradiate contaminants, and photocatalytic materials of elements of said air filtration medium enabling better oxidation of contaminants.

10. An air filtration apparatus as described in claim 2, wherein said ultraviolet light source is inserted into a linear pleat of said air filtration medium.

11. An air filtration apparatus as described in claim 1, further comprising a power mediation unit intermediate said ultraviolet light source and a source of power for said ultraviolet light source, said power mediation unit being adapted for at least one of: direct correction to the main power feed of an air handling unit and connection to a local electrical outlet.

12. An air filtration apparatus as described in claim 11, wherein said power mediation unit is adapted for placement in at least one of: an interior of an air handling unit, and an interior of an air duct.

13. An air filtration apparatus with ultraviolet light, comprising:
an ultraviolet light source, which ultraviolet light source is adapted to fit into a filter mount adapted to fit within a filter access port for a re-circulating air system; and
a safety interlock causing said ultraviolet light source to cease emitting ultraviolet light when a filter mount containing said ultraviolet light source is withdrawn from a filter access port.

14. An air filtration apparatus with ultraviolet light as described in claim 13, wherein a safety interlock housing provides said safety interlock, which safety interlock housing is electrically connected to said ultraviolet light source and is adapted to connect to a filter mount for said ultraviolet light source.

15. An air filtration apparatus with ultraviolet light as described in claim 14, further including a filter mount containing said ultraviolet light source and connected to said safety interlock housing.

16. An air filtration apparatus as described in claim 15, further including an air filtration medium in said filter mount.

17. An air filtration apparatus as described in claim 16, wherein said ultraviolet light is positioned so as to irradiate said air filtration medium.

18. An air filtration apparatus as described in claim 16, wherein said ultraviolet light source is positioned at least one of: adjacent said air filtration medium and in said air filtration medium.

19. An air filtration apparatus as described in claim 13, further comprising a reflector to direct ultraviolet light emitted by said ultraviolet light source.

20. An air filtration apparatus as described in claim 19, wherein said reflector directs a portion of said ultraviolet in the direction of air flow of a recirculating air system.

21. An air filtration apparatus as described in claim 16, wherein at least one of filtration and sterilization by said air filtration medium is enhanced by factors enabling elements of said air filtration medium to at least one of: better attract contaminants, better retain contaminants, better irradiate contaminants with ultraviolet light and better oxidize contaminants.

22. An air filtration apparatus as described in claim 21, wherein said factors include at least one of: an electric charge on elements of said air filtration medium enabling said elements to better attract and retain contaminants, tackification of elements of said air filtration medium enabling said elements to better retain contaminants, and ultraviolet light conductivity of elements of said air filtration medium enabling said ultraviolet light to better irradiate contaminants, and photocatalytic materials of elements of said air filtration medium enabling better oxidation of contaminants.

23. An air filtration apparatus as described in claim 16, wherein said ultraviolet light source is inserted into a linear pleat of said air filtration medium.

24. An air filtration apparatus as described in claim 13, further comprising a power mediation unit intermediate said ultraviolet light source and a source of power for said ultraviolet light source, said power mediation unit being adapted for at least one of: direct connection to the main power feed of an air handling unit and connection to a local electrical outlet.

25. An air filtration apparatus as described in claim 24, wherein said power mediation unit is adapted for placement in at least one of: an interior of an air handling unit, and an interior of an air duct.

26. An air filtration apparatus with ultraviolet light, comprising:
an ultraviolet light source, which ultraviolet light source is adapted to fit into a filter mount adapted to fit within a filter access port for a recirculating air system; and
a power mediation unit intermediate said ultraviolet light source and a source of power for said ultraviolet light source, said power mediation unit being adapted for at least one of: direct connection to the main power feed of an air handling unit and connection to a local electrical outlet.

27. An air filtration apparatus as described in claim 26, wherein said power mediation unit is adapted for placement in at least one of an interior of an air handling unit, and an interior of an air duct.

28. An air filtration apparatus as described in claim 26, further including a safety interlock causing said ultraviolet light source to tease emitting ultraviolet light when a filter mount containing said ultraviolet light source is withdrawn from a filter access port.

29. An air filtration apparatus with ultraviolet light as described in claim 28, wherein a safety interlock housing provides said safety interlock, which safety interlock housing is electrically connected to said ultraviolet light source and is adapted to connect to a filter mount for said ultraviolet light source.

30. An air filtration apparatus with ultraviolet light as described in claim 29, further including a filter mount containing said ultraviolet light source and connected to said safety interlock housing.

31. An air filtration apparatus as described in claim 30, further including an air filtration medium in said filter mount.

32. An air filtration apparatus as described in claim 31, wherein said ultraviolet light is positioned so as to irradiate said air filtration medium.

33. An air filtration apparatus as described in claim 31, wherein said ultraviolet light source is positioned at least one of: adjacent said air filtration medium and in said air filtration medium.

34. An air filtration apparatus as described in claim 26, further comprising a reflector to direct ultraviolet light emitted by said ultraviolet light source.

35. An air filtration apparatus as described in claim 34, wherein said reflector directs a portion of said ultraviolet in the direction of air flow of a recirculating air system.

36. An air filtration apparatus as described in claim 32, wherein at least one of filtration and sterilization by said air filtration medium is enhanced by factors enabling elements of said air filtration medium to at least one of: better attract contaminants, better retain contaminants, better irradiate contaminants with ultraviolet light, and better oxidize contaminants.

37. An air filtration apparatus as described in claim 36, wherein said factors include at least one of: an electric charge on elements of said air filtration medium enabling said elements to better attract and retain contaminants, tackification of elements of said air filtration medium enabling said elements to better retain contaminants, and ultraviolet light conductivity of elements of said air filtration medium enabling said ultraviolet light to better irradiate contaminants, and photocatalytic materials of elements of said air filtration medium enabling better oxidation of contaminants.

38. An air filtration apparatus as described in claim 31, wherein said ultraviolet light source is inserted into a linear pleat of said air filtration medium.
